(19) United States
(12) Patent Application Publication
(10) Pub. No.: US 2015/0088735 A1
(43) Pub. Date: Mar. 26, 2015

(54) CHIP CARD DEPLOYMENT DRIVEN BY TRAVEL ITINERARY METHOD AND APPARATUS

(71) Applicant: MASTERCARD INTERNATIONAL INCORPORATED, Purchase, NY (US)

(72) Inventor: Justin X. HOWE, Oakdale, NY (US)

(73) Assignee: MASTERCARD INTERNATIONAL INCORPORATED, Purchase, NY (US)

(21) Appl. No.: 14/038,259

(22) Filed: Sep. 26, 2013

(51) Int. Cl. G06Q 20/34

(52) U.S. Cl. CPC G06Q 20/341
USPC 705/41

(57) ABSTRACT

A system, method, and computer-readable storage medium to issue CHIP-enabled payment cards to cardholders based on their propensity to travel to locations where the use of CHIP is dominant.

### BACKGROUND

1. Field of the Disclosure

Aspects of the disclosure relate in general to financial services. Aspects include an apparatus, system, method and computer-readable storage medium to deploy chip-card payment cards to payment cardholders based on their propensity to travel to locations where the use of chip payment cards is dominant.

2. Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards.

Payment cards provide the clients of a financial institution (“cardholders”) with the ability to pay for goods and services without the inconvenience of using cash. For example, traditionally, whenever travelers leave home, they carried large amounts of cash to cover journey expenditures, such as transportation, lodging, and food. Payment cards eliminate the need for carrying large amounts of currency. Moreover, in international travel situations, payment cards obviate the hassle of changing currency.

In addition to currency issues, travelers using payment cards have other problems. In the United States, most payment card issuers send payment cards with magnetic stripes whereas in many other parts of the world, the use of chip-enabled payment cards is dominant. As used herein, a chip-enabled payment card (or CHIP) is a payment card that contains an imbedded computer chip that communicates with a point-of-sale (POS) device to exchange certain information in furtherance of a financial transaction. CHIP payments cards can be used to complete a payment in lieu of using a magnetic stripe.

### SUMMARY

Embodiments include a system, device, method and computer-readable medium to deploy chip-card payment cards to payment cardholders based on their propensity to travel to locations where the use of CHIP is dominant.

In one embodiment, a system comprises a network interface and a processor. The network interface is configured to receive payment card transaction data from a merchant bank. The transaction data includes a cardholder identifier associated with a customer, addenda for the transaction data, and a vendor. The processor is configured to extract travel information from the addenda. The travel information includes an anticipated location. The processor matches the anticipated location against a database of predetermined locations where CHIP-enabled cards are used. The network interface is further configured to transmit to an issuer a message when the anticipated location matches against the database of locations where CHIP-enabled cards are used. The message informs the issuer of impending travel by the customer.

### BRIEF DESCRIPTION OF THE DRAWINGS

FIG. 1 is a block diagram illustrating a system to issue CHIP-enabled payment cards to cardholders based on their propensity to travel to locations where the use of CHIP is dominant.

FIG. 2 is an expanded block diagram of an exemplary embodiment of a server architecture of a payment processor embodiment configured to issue CHIP-enabled payment cards to cardholders based on their propensity to travel to locations where the use of CHIP is dominant.

FIG. 3 illustrates a method to issue CHIP-enabled payment cards to cardholders based on their propensity to travel to locations where the use of CHIP is dominant.

### DETAILED DESCRIPTION

One aspect of the disclosure includes that the realization cardholder travel to locations may be predicted by cardholder spending. Further, a system and method may parse anticipated cardholder travel from cardholder travel purchases. Outside the United States, many locations use CHIP-enabled payment cards (also referred to as “smart cards”). These CHIP-enabled payment cards may comply with the International Organization for Standardization (ISO) and the International Electrotechnical Commission (IEC) Standard 7816 (ISO/IEC 7816). Whenever cardholders intend to travel to locations where the use of CHIP-enabled payment cards is dominant, an issuer financial institution or payment network can predict the travel and send a cardholder a new CHIP-enabled payment card. In such a system, the payment card network or issuer financial institution may predict the travel, and alert the issuer to send the CHIP-enabled payment card to the cardholder in anticipation of their expected travel.

While some of the embodiments described herein are applied to a cross-border context, it is understood by those familiar with the art that the concepts, apparatus, system and methods described herein may also be applicable to domestic travel to locations where the use of CHIP-enabled cards is dominant.

The systems and processes are not limited to the specific embodiments described herein. In addition, components of each system and each process can be practiced independently and separately from other components and processes described herein. Each component and process also can be used in combination with other assembly packages and processes.

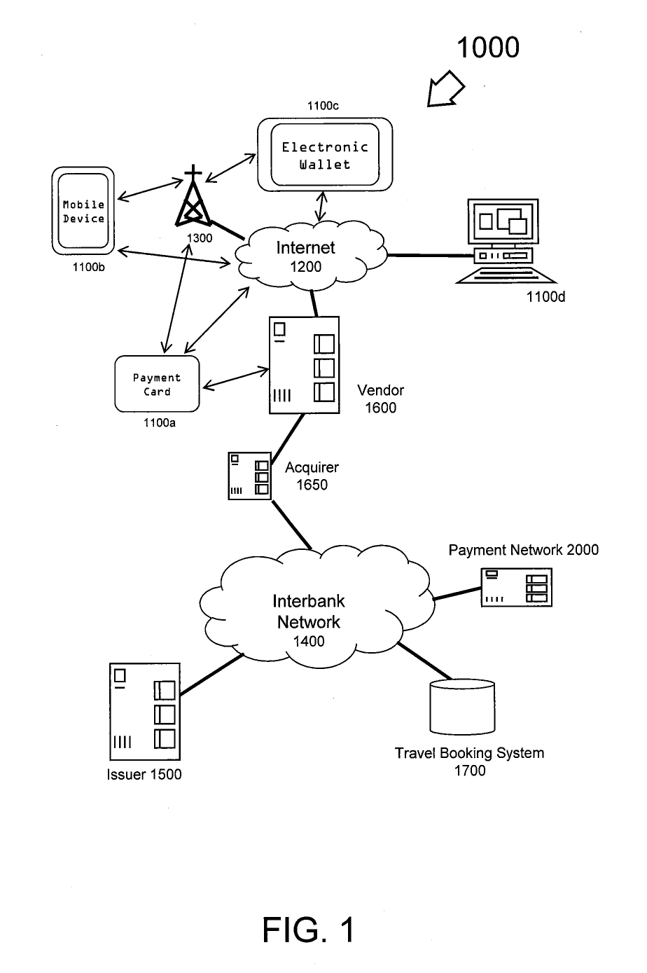

FIG. 1 is a block diagram 1000 illustrating a financial transaction using a payment card payment system configured to issue CHIP-enabled payment cards to cardholders based on their propensity to travel to locations where the use of CHIP is dominant.

It is understood that the travel prediction may occur at either at an issuer or at a payment network. For sake of example only, the present disclosure will describe a payment network-based system, such as the payment system using the MasterCard® interchange, Cirrus® network, or Maestro®. The MasterCard interchange is a proprietary communications standard promulgated by MasterCard International Incorporated for the exchange of financial transaction data between financial institutions that are customers of MasterCard International Incorporated. Cirrus is a worldwide interbank network 1400 operated by MasterCard International Incorporated linking debit and payment cards to a network of ATMs throughout the world. Maestro is a multi-national debit card service owned by MasterCard International Incorporated.

In a financial payment system, a financial institution called the “issuer” 1500 issues a payment card to a consumer, who uses payment card 1100a to tender payment for a cross-border purchase from a vendor 1600 or withdraw cash from an Automated Teller Machine. In addition to payment cards 1100a, it is understood by those familiar with the art that the process herein applies equally to mobile device 1100b (such as key fobs, mobile phones, tablet computers, and the like), electronic wallets 1100c, or computers 1100d, connected to vendor 1600 via a mobile telephone network 1300 or the Internet 1200.

In one example, a cardholder presents the payment card to a point-of-sale device at a vendor 1600. In another example, cardholder may transact with vendor 1600 via a mobile telephone network 1300 or the Internet 1200 in an e-commerce transaction.

The vendor 1600 is affiliated with a financial institution. This financial institution is usually called the “merchant bank,” “acquiring bank,” “acquirer bank” or “acquirer” 1650. When a payment card 1100a is tendered at a vendor 1600, the vendor 1600 electronically requests authorization from the acquirer 1650 for the amount of the purchase. The request is performed electronically with the consumer's account information from the magnetic stripe on the payment card or for CHIP enabled payment cards, via the computer chip imbedded within the card 1100a. The account information and transaction information are forwarded to transaction processing computers of the acquirer 1650. Alternatively, an acquirer 1650 may authorize a third party to perform transaction processing on its behalf. In this case, the vendor 1600 will be configured to communicate with the third party. Such a third party is usually called a “merchant processor” or an “acquiring processor.”

In instances where a cardholder is purchasing a travel-related service from a vendor 1600, such as plane, train, bus, or other travel tickets, hotels, rental-cars and the like, the transaction information contains addenda describing the purchase. For example, suppose the cardholder is purchasing plane tickets from New York City to San Francisco, Calif. The addenda may include itinerary information such as dates of travel, the airline and flight number, and origination/destination airport codes for the flights. This itinerary information can alternatively be sourced from a Global Distribution System or other travel data provider. As understood in the art, a Global Distribution System is generally a network that enables transactions between travel service providers (e.g., airlines, train operators, rental car companies) and travel reservation agents in order to provision travel-related services to end users.

Using a payment network 2000, the computers of the acquirer 1650 or the merchant processor will communicate via an interbank network 1400 authorization message or PIN network with the computers of the issuer 1500 to determine whether the consumer's account is in good standing and whether the transaction is likely to be fraudulent.

When a request for authorization is accepted, the available credit balance of cardholder's account is decreased, and a payment is later made to vendor 1600 via acquirer 1650.

After a transaction is captured, the transaction is settled between the vendor 1600, the acquirer 1650, and the issuer 1500. As described herein, the term “payment card” includes cards such as credit cards, charge cards, and debit cards, but also includes any other devices that may hold payment account information, such as mobile phones, personal digital assistants (PDAs), cloud-based accounts, cashless payment devices/methods, and key fobs.

After the financial transaction has occurred, the payment network 2000 analyzes anticipated travel information derived from the transaction addenda that has been corrected by a travel booking system 1700. An example travel booking system 1700 is a Global Distribution Systems database. As is understood in the art, a Global Distribution Systems database is a data provider of airline itineraries. It is understood that other itineraries may also be included, such as train, bus, and rental car pick-up/return locations. In yet other embodiments, a credit reporting agency, payment card issuer 1500, travel booking system 1700 and/or payment network 2000 may track anticipated travel information. Based on these “propensity to travel” determinations by payment network 2000, the intended travel location is analyzed. When the intended travel location is an area where CHIP-enabled cards are prevalent, then the issuer is informed that the issuance of a CHIP-enabled payment card to the cardholder is appropriate.

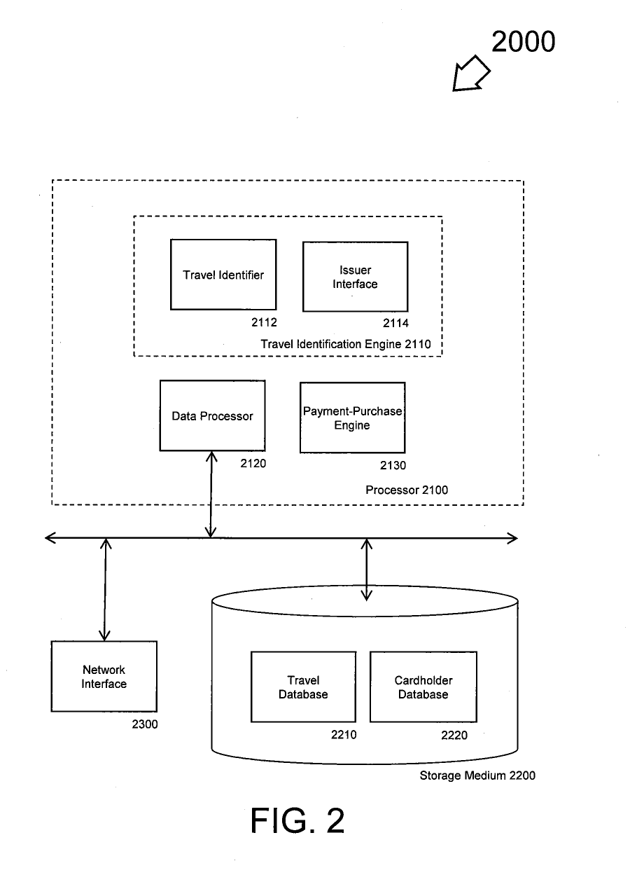

Embodiments will now be disclosed with reference to a block diagram of an exemplary payment server of FIG. 2, configured to issue CHIP-enabled payment cards to cardholders based on their propensity to travel to locations where the use of CHIP is dominant, constructed and operative in accordance with an embodiment of the present disclosure. While the embodiment shown in FIG. 2 indicates that the payment server resides in the payment network 2000, it should be understood by those familiar with the art that a payment server may also exist at an issuer 1500, at a travel booking system 1700, or at a credit reporting agency.

Payment server may run a multi-tasking operating system (OS) and include at least one processor or central processing unit (CPU) 2100, a non-transitory computer-readable storage media 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a travel identification engine 2110, payment-purchase engine 2130, and a data processor 2120.

Data processor 2120 interfaces with storage media 2200 and network interface 2300. The data processor 2120 enables processor 2100 to locate data on, read data from, and writes data to, these components.

Payment-purchase engine 2130 performs payment and purchase transactions, and may do so in conjunction with travel identification engine 2110.

Travel identification engine 2110 is the structure that enables identifying intended cardholder travel, and informs the issuer that the issuance of a CHIP-enabled card is appropriate, and may further comprise: a travel identifier 2112, and an issuer interface 2114.

Travel identifier 2112 analyzes the addenda of financial transactions to identify anticipated future travel by a cardholder.

Issuer interface 2114 is a structure configured to communicate information to an issuer regarding the issuance of a CHIP-enabled card to the cardholder.

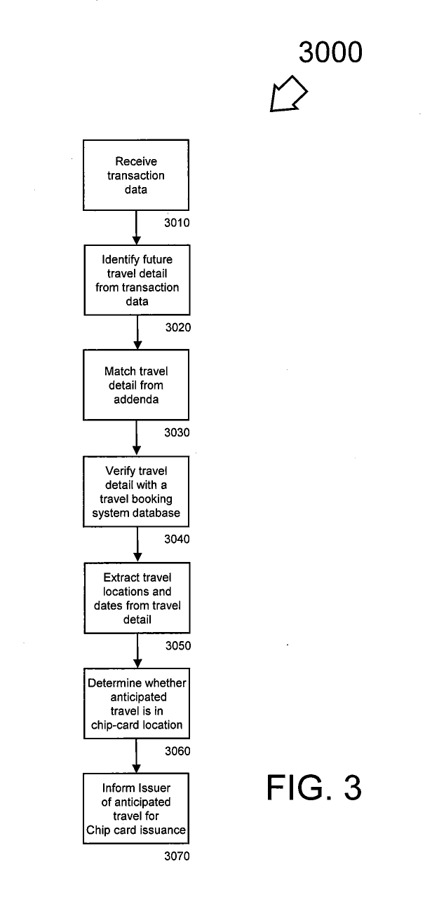

The functionality of all the travel identification engine 2110 structures is elaborated in greater detail in FIG. 3.

These structures may be implemented as hardware, firmware, or software encoded on a computer readable medium, such as storage media 2200. Further details of these components are described with their relation to method embodiments below.

Non-transitory computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage media 2200 may be remotely located from processor 2100, and be connected to processor 2100 via a network such as a local area network (LAN), a wide area network (WAN), or the Internet.

In addition, as shown in FIG. 2, storage media 2200 may also contain a travel database 2210, and a cardholder database 2220. Travel identification engine 2110 may store data related to cardholder payment credit, debit, or charge information in a cardholder database 2220; in some embodiments, cardholder database 2220 may also store cardholder telephone numbers and electronic mail addresses as well as a cardholder spending profile. A cardholder spending profile may be a history of expenditures made by a cardholder, a model of the cardholder spending pattern, or other method of profiling cardholder expenditures. Additionally, travel database 2210 may store data related to anticipated cardholder travel. It is understood by those familiar with the art that one or more of these databases 2210-2220 may be combined in a myriad of combinations.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment server to communicate with vendor 1600 and issuer 1500.

We now turn our attention to method or process embodiments of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the disclosure.

Embodiments create a spend-derived profile to anticipate cardholder travel to a destination. FIG. 3 illustrates a process 3000 to issue CHIP-enabled payment cards to cardholders based on their propensity to travel to locations where the use of CHIP is dominant, constructed and operative in accordance with an embodiment of the present disclosure. It is understood by those familiar with the art that process 3000 may be a non-real time clearing process, but in alternate embodiments may be a real time process. Conventionally, a clearing process is a non-real time process. Furthermore, it is understood that process 3000 or variations thereof may occur at an issuer 1500, at a travel booking system 1700, at a credit reporting agency, or at a payment network 2000. For the sake of example only, this disclosure will discuss a payment network 2000 embodiment.

At block 3010, payment network 2000 receives transaction data from a merchant bank. The transaction data is received electronically via a network interface, and may be part of data from many transactions received via a batch process.

In non-payment network, embodiments, the transaction data may be received by an issuer 1500, a travel booking system 1700, or a credit reporting agency from a vendor 1600 or payment network 2000.

At block 3020, the travel identifier 2112 of the travel identification engine 2110 analyzes the batch-received transactions in order to identify future travel detail from transaction data.

At block 3030, travel identifier 2112 determines whether the travel-related transaction has correctly provided traveler itinerary information encoded within addenda associated with the travel-related transaction. These addenda messages are populated by travel providers (such as airlines) and travel agencies at the time payment for a booking is made. Such itinerary information may include the name of the traveler, the travel destination/departure points, and date of travel.

In some instances, the addenda are incomplete. In such instances, travel identifier 2112 verifies the travel itinerary information against a database of a travel booking system 1700, block 3040. Such a database includes flight details, and pricing on many flights. As part of the verification process, the addenda are corrected and travel details are added, if necessary.

At block 3050, the transaction addenda data is parsed to determine and extract itinerary information from the travel-related data, including transaction dates, times, and locations for the travel-related transaction. The travel-related transaction data may relate to any travel-related data known in the art, such as a purchase or reservation of airline tickets, train tickets, bus tickets, hotel reservations or payments, rental car reservations, cruise tickets or reservations, or experience-ticket purchases (such as theater or show tickets).

At block 3060, the anticipated travel is matched against a list of known locations where CHIP-enabled payment cards are used. It is understood that such a list of known locations may be stored in travel database 2210, and may be derived by the processing of payment network 2000. In some embodiments, the match may adjust or extrapolate location information to proximate locations, based on city, metropolitan area, county, state, province or country. In other embodiments, the search may adjust or extrapolate location information based on distance from the anticipated travel. For example, location matches within 1, 2, 5, 10, or 20 mile radius of the anticipated travel location may be searched.

At block 3070, if the anticipated travel matches against a list of known locations where CHIP-enabled payment cards are used, the issuer 1500 is electronically informed of impending travel to known locations where CHIP-enabled payment cards are used. The issuer interface 2114 communicates to issuer 1500 via the network interface 2300. Note that the actual location where CHIP-enabled payment cards are used does not need to be disclosed to the issuer 1500, but some embodiments may do so.

In yet other embodiments, the issuer interface 2114 also discloses the time period (including an anticipated begin date and/or an anticipated end date) of the impending travel. Disclosing temporal information allows the issuer 1500 to factor in the impending travel time period into the issuance of the CHIP-enabled payment card, and may also assist in potential fraud prevention.

Once informed, the issuer 1500 may then send cardholder a CHIP-enabled payment card. In some embodiments, the CHIP-enabled payment card will automatically be created with a PIN number identical to the cardholder's non-CHIP-enabled payment card. It is understood that issuer 1500 may not issue the cardholder a CHIP-enabled payment card if the cardholder has already been issued such a card. It is further understood, that in such embodiments, an issuer 1500 may send the cardholder reminders of what the PIN is, in cases where the cardholder has not used the PIN functionality of the card.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving, via a network interface, payment card transaction data from a merchant bank, the transaction data including a cardholder identifier associated with a customer, addenda for the transaction data, and a vendor;
extracting travel information from the addenda with a processor, the travel information including an anticipated location;
matching the anticipated location, with the processor, against a database of predetermined locations where CHIP-enabled cards are used; and
transmitting to an issuer a message via the network interface, the message informing the issuer of impending travel by the customer when the anticipated location matches against the database of locations where CHIP-enabled cards are used.

2. The processing method of claim 1, further comprising:
verifying the travel information with a travel booking system.

3. The processing method of claim 2, wherein the travel information includes an anticipated time period with an anticipated begin date.

4. The processing method of claim 3, wherein the message informing the issuer of impending travel by the customer includes the anticipated begin date.

5. The processing method of claim 4, wherein the message informing the issuer of impending travel by the customer includes the anticipated location.

6. The processing method of claim 5, wherein the issuer sends the cardholder a CHIP-enabled payment card or reminder of a PIN for the CHIP-enabled payment card.

7. The processing method of claim 6, the message informing the issuer of impending travel by the customer includes the anticipated time period.

8. A system comprising:
a network interface configured to receive payment card transaction data from a merchant bank, the transaction data including a cardholder identifier associated with a customer, addenda for the transaction data, and a vendor;
a processor configured to extract travel information from the addenda, the travel information including an anticipated location, to match the anticipated location against a database of predetermined locations where CHIP-enabled cards are used; and
wherein the network interface is further configured to transmit to an issuer a message, the message informing the issuer of impending travel by the customer when the anticipated location matches against the database of locations where CHIP-enabled cards are used.

9. The system of claim 8, wherein the processor is further configured to verify the travel information with a travel booking system.

10. The system of claim 9, wherein the travel information includes an anticipated time period with an anticipated begin date.

11. The system of claim 10, wherein the message informing the issuer of impending travel by the customer includes the anticipated begin date.

12. The system of claim 11, wherein the message informing the issuer of impending travel by the customer includes the anticipated location.

13. The system of claim 12, wherein the issuer sends the cardholder a CHIP-enabled payment card or reminder of a PIN for the CHIP-enabled payment card.

14. The system of claim 13, the message informing the issuer of impending travel by the customer includes the anticipated time period.

15. A non-transitory computer readable medium encoded with data and instructions, when executed by a computing device the instructions causing the computing device to:
receive, via a network interface, payment card transaction data from a merchant bank, the transaction data including a cardholder identifier associated with a customer, addenda for the transaction data, and a vendor;
extract travel information from the addenda with a processor, the travel information including an anticipated location;
match the anticipated location, with the processor, against a database of predetermined locations where CHIP-enabled cards are used; and
transmit to an issuer a message via the network interface, the message informing the issuer of impending travel by the customer when the anticipated location matches against the database of locations where CHIP-enabled cards are used.

16. The non-transitory computer readable medium of claim 15, the instructions further causing the computing device to:
verify the travel information with a travel booking system.

17. The non-transitory computer readable medium of claim 16, wherein the travel information includes an anticipated time period with an anticipated begin date.

18. The non-transitory computer readable medium of claim 17, wherein the message informing the issuer of impending travel by the customer includes the anticipated begin date.

19. The non-transitory computer readable medium of claim 18, wherein the message informing the issuer of impending travel by the customer includes the anticipated location.

20. The non-transitory computer readable medium of claim 19, wherein the issuer sends the cardholder a CHIP-enabled payment card or reminder of a PIN for the CHIP-enabled payment card.
